(19) United States
(12) Patent Application Publication
(10) Pub. No.: US 2007/0223985 A1
(43) Pub. Date: Sep. 27, 2007

(54) Pencils and Methods for Their Production

(75) Inventors: Yann Bourgeois, Petit-Roeulx-Lez-Nivelles (BE); Said Rachidi, Quaregnon (BE); Bronislav Henri May, Overijse (BE); Paul Andre Gollier, Waterloo (BE)

Correspondence Address: BACON & THOMAS, PLLC, 625 SLATERS LANE, FOURTH FLOOR, ALEXANDRIA, VA, 22314, US

(73) Assignee: CERTECH ASBL, Seneffe (BE)

(21) Appl. No.: 11/578,841

(22) PCT Filed: Apr. 19, 2005
(86) PCT No.: PCT/EP05/04259

§ 371 Date: Oct. 19, 2006

(30) Foreign Application Priority Data
Apr. 20, 2004 (GB) 0408750.8

(51) Int. Cl. A45D 40/20; B43K 19/00; B43K 19/14

(52) U.S. Cl. 401/88; 264/239

(57) ABSTRACT

Pencils having a core within a barrel, the barrel being formed from a blend of at least two transparent polymers which are incompatible and form separate phases within the blend, the polymers having refractive indices which differ by not more than 0.02 when measured under substantially the same conditions. Blends for use in producing the barrels of such pencils have shown good sharpenability combined with high transparency. The latter enables the core of the pencils to be clearly visible through their barrels.

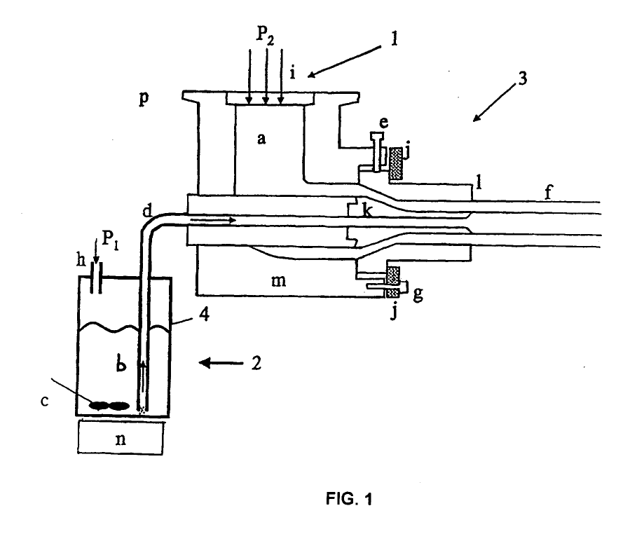

This invention concerns pencils, and methods for their production.

Conventional pencils consist of a central core of a “lead” material set within a tubular external tube or barrel which is traditionally made of wood. Wood has desirable properties for this purpose because it can be easily cut away or sharpened to reveal fresh core material or “lead” when the latter has been used up.

U.S. Pat. Nos. 2,790,202 and 2,988,784 describe the production of pencils by coextruding a thermoplastic or a solid core “lead” with an external barrel formed from wood flour and a thermoplastic binder.

FR 1588294 describes the production of pencils by coextruding a core material and a polystyrene based material plus a gaseous expander to produce a foamed barrel. The bubbles in the barrel material serve both to increase the sharpenability of the barrel and to reduce its density, thereby mimicking some of the properties of natural wood.

US 2003022962 describes the production of pencils which have outer barrels formed from styrenic polymers or copolymers filled with wood fiber and a compatibilizer, and again the barrels are opaque.

U.S. Pat. No. 5,360,281 describes the production of cosmetic pencils by extruding tubular barrels formed from a polymeric material and a foaming agent, and then filling the barrels with the lead material. Again, the barrels of these pencils are opaque due to the presence of bubbles in the barrel material.

Opaque barrels are a disadvantage where it is desirable for a user to be able to see the color of the “lead” through the barrel of the pencil rather than from an exposed sharpened end, for example, with cosmetic pencils.

US 2001048839 attempts to address the problem of the opacity of prior art pencil barrels by making them from blends consisting of a continuous phase of a polypropylene-based polymer and a styrenic-resin based disperse phase. These pencils are said to be sharpenable and they are also described as being “not completely transparent” but having “enough transparency to distinguish the color tone of the stored cosmetic material . . . from the outside.” Thus they still have poor optical properties.

According to the present invention there are provided pencils having a core within a barrel, the barrel comprising a blend of at least two transparent polymers which are incompatible and form separate phases within the blend, the polymers having refractive indices which differ by not more than 0.02 when measured under substantially the same conditions.

Pencils in accordance with the present invention can be produced having high degrees of transparency. For example, Courier 12pt type can in many cases be read through stacks of ten or more 2 mm sheets formed from the blends, that is through a total thickness of 20 mm or more of the blends. Polymers and blends having these optical properties are considered herein to be crystal clear. Furthermore, such blends have shown good sharpenability when used as pencil barrels.

Pencils in accordance with the present invention have also shown good sharpenability which is believed to result from the incompatibility between the polymeric components of the blends.

Blends used to form pencil barrels in accordance with the present invention can comprise syndiotactic polypropylene, polystyrene, or a cyclic olefin copolymer, all of which are usually crystal clear as defined herein, with a further transparent polymer having a refractive index not more than 0.02 above or below that of the syndiotactic polypropylene, the styrene homopolymer, or the cyclic olefin copolymer.

Crystal clear grades of syndiotactic polypropylene in general have a refractive index of about 1.492 and crystal clear grades of styrene homopolymers generally have a refractive index of about 1.60.

Such polymers will usually contain little if any comonomers. However, if comonomers are present they should not be present in amounts which (a) significantly affect the clarity of the polymers, (b) compatibilizes blends with the second polymer, or (c) alter the refractive index of the polymers by more than 0.01 compared with corresponding polymers containing substantially no comonomers.

Examples of transparent polymers having a refractive index of from 1.48 to 1.50, which is not more than 0.02 above or below that of syndiotactic polypropylene, include polyvinyl acetal, cellulose acetate, poly-(oxymethylene), polyvinyl butyral, poly-(n-hexyl methacrylate), poly-(n-butyl methacrylate), poly-(ethylidene methacrylate), poly-(2-ethoxyethyl methacrylate), poly-(ethylene maleate), poly-(n-propyl meth-acrylate), poly-(3,3,5-trimethyl-cyclohexyl methacrylate), poly-(ethyl methacrylate), poly-(2-nitro-2-methylpropyl meth-acrylate), poly-(triethylcarbinyl methacrylate), poly-(1,1-diethyl methacrylate), poly-(methyl methacrylate), poly-(2-decyl-butal, 3-diene), polyvinyl alcohol, poly-(ethylglycolate methacrylate), poly-(3-methylcyclohexyl methacrylate), poly-(cyclohexyl α-ethoxyacrylate), methyl cellulose, poly-(4-methylcyclohexyl methacrylate), and poly-(decamethylene glycol dimethacrylate).

Preferred examples of transparent polymers for use in accordance with the present invention which have refractive indices which are not more than 0.02 above or below that of polystyrene include polycarbonates and more particularly bisphenol-A polycarbonates.

Other polymers which are incompatible with polystyrene and have refractive indices not more than 0.02 above or below that of styrene homopolymers include poly-(1,2-diphenyethyl meth-acrylate), poly-(o-chlorobenzyl methacrylate), poly-(oxy-carbonyloxy-1,4-phenylene-sec-butylidene-1,4-phenylene), poly-(oxypentaerythritoloxyphthaloyl), poly-(m-nitrobenzyl methacrylate), poly-(oxycarbonyloxy-1,4-phenyleneisopropylidene-1,4-phenylene), poly-(N-(2-phenylethyl methacrylamide), poly-(oxycarbonyloxy-1,4-phenylenecyclohexylidene-1,4-phenylene), poly-(diphenylmethyl methacrylate), poly-(oxycarbonyloxy-1,4-phenyleneethylidene-1,4-phenylene), poly-(p-bromophenyl methacrylate), and poly-(N-benzyl methacrylamide), all of which having refractive indices above 1.58.

Examples of transparent polymers which can be used in accordance with the present invention in blends with cyclic olefin copolymers include polyamides, e.g. nylons, and styrene/butadiene copolymers.

Blending of the incompatible transparent polymers is preferably effected using a relatively low shear rate, for example using a mono-screw process rather than a twin-screw process, as this has been found to improve the sharpenability of the blend. This latter property is obviously desirable for “wood” materials for pencils.

Blends of the present invention preferably consist of the two or more of the specified types of material. However, they can contain other materials provided they do not significantly adversely affect the optical properties of the blends, and more particularly pencil barrels produced from them. For example, they can contain an internal lubricant, e.g. calcium stearate, with the object of improving the sharpenability of the blends by reducing frictional forces between pencil sharpeners and the pencil. The blends can contain other additives, for example chemical stabilizers, processing aids and additives which increase the melt strength or the stiffness of the finished blends.

Blends used in accordance with the present invention can contain other additives, for example transparent mineral fillers, for example to increase matrix adhesion between the incompatible polymers, provided they have refractive indices which are no more or less than 0.02 different from the transparent incompatible polymers.

The amounts of incompatible blends used to form the barrels of pencils in accordance with the present invention can be varied widely. However, in general the blends will contain at least 10% by weight of each of the incompatible transparent polymers.

Preferred incompatible blends for use in accordance with the present invention contain from 40 to 90% by weight of syndiotactic polypropylene.

The present invention further provides a method of producing pencils in accordance with the present invention which comprises coextruding a lead forming material and a barrel forming material, the barrel forming material comprising a blend of incompatible transparent polymers having refractive indices which differ by not more than 0.02 when measured under substantially the same conditions.

The pencils can as a result be obtained in a single step.

A method of producing pencils in accordance with the present invention will now be described with reference to the accompanying drawing which is a vertical section through an embodiment of a die system for producing such pencils.

The illustrated system consists of an inlet manifold 1 for receiving molten polymer (a) for forming the “wood” of the pencils from an extruder (not shown), a supply device 2 for supplying a melt of the “lead” material for the pencils, and a flow combining die shown generally at 3 for producing a substantially cylindrical flow of molten material from the supply system 2 within a substantially tubular flow of molten polymer from the manifold 1.

The supply system 2 consists of a closed container 4 in which material for forming the “lead” of the pencils (b) is melted using an external heater (n). Pressure P₁ applied to the interior of the container 4 forces molten material (b) through a conduit (d) to the flow combining die 3.

A melt (a) of a polymer blend for the “wood” of the pencils is simultaneously introduced into the manifold 1 under pressure P₂, which in practice will usually be from several tens to several hundreds of bar, from an extruder (not shown).

The flow combining die 3 includes a die pin (k) with a central bore through which the melt of the “lead” of the pencils (b) flows, and a circular section die (1) within which is positioned the die pin (k) and through which the polymer blend for the “wood” is coextruded with the flow from the die pin (k).

The second die (1) is held in place with an annular ring (j) held in place by bolts (g), and the position of the die (1) relative to the pin (k) is adjustable using adjustment screws (e).

The polymer blend is supplied to the manifold 1 under a pressure P₂, which will typically be from several tens to several hundreds of bar, and the pressure P₁ applied to the container 4 will typically be between 0 and 200 mbar above atmospheric pressure, the pressure P₁ being such as to prevent the tube of the blend from collapsing or from inflating by respectively increasing or decreasing the pressure P₁.

The resultant coextrudate is cooled to form a solid coextrudate (f) which can be cut into individual pencils.

The external shape of pencils in accordance with the present invention can be substantially cylindrical or ellipsoidal in cross section, or they can be polygonal in cross section, for example substantially triangular or hexagonal.

The following Examples are given by way of illustration only. All parts are by weight unless stated otherwise.

### EXAMPLE 1

Isotactic polypropylene with a high ethylene content was extruded to form a sheet 2 mm thick. Courier 12pt text could be read through a stack of no more than four of strips of this sheet, i.e. through 8 mm. Pencils made using this polymer for their barrels were hard to sharpen.

### EXAMPLE 2

Crystal clear syndiotactic polypropylene (refractive index 1.492) was used to form pencil barrels. Courier 12pt text could be read through a stack of at least ten strips of this sheet, i.e. through at least 20 mm. These pencils were difficult to sharpen.

### EXAMPLE 3

90% by weight of the crystal clear syndiotactic polypropylene used in Example 2 were blended with 10% by weight of acrylonitrile/butadiene/styrene block copolymer (refractive index >1.53). The mixture was opaque, i.e. it was impossible to read 12pt Courier text through a single 2 mm thick sheet of this material, but pencils having barrels made from this blend were easy to sharpen.

### EXAMPLE 4

80% by weight of the crystal clear syndiotactic polypropylene used in Example 2 were blended with 20% by weight of polymethyl methacrylate (refractive index 1.492). Courier 12pt text could be read through a stack of no more than six 2 mm thick sheets of this blend, i.e. 12 mm total thickness. Pencils having barrels made from this blend were easy to sharpen.

### EXAMPLE 5

70% by weight of the crystal clear syndiotactic polypropylene used in Example 2 were blended with 20% by weight of the polymethyl methacrylate used in Example 4 and 10% by weight of a tackifying resin (a fully saturated cycloaliphatic hydrocarbon; T_{g}>100° C. which increased the T_{g} of the blend). The blend was crystal clear, Courier 12pt text being readable through a stack of more than ten 2 mm thick sheets of this blend (total thickness greater than 20 mm).

Pencils with barrels made from this blend were easy to sharpen.

### EXAMPLE 6

35% by weight of the crystal clear syndiotactic polypropylene used in Example 2 were blended with 60% by weight of polymethyl methacrylate used in Example 4 and 5% by weight of a tackifying resin (a fully saturated cycloaliphatic hydrocarbon; T_{g}>100° C. which increased the T_{g} of the blend). The blend was crystal clear, Courier 12pt text being readable through a stack of more than ten 2 mm thick sheets of this blend (total thickness greater than 20 mm).

Pencils with barrels made from this blend were easy to sharpen.

### EXAMPLE 7

80% by weight of the crystal clear syndiotactic polypropylene used in Example 2 were blended with 20% by weight of polyvinyl butyral (refractive index 1.49). Courier 12pt text could be read through a stack of eight 2 mm thick sheets of this blend (total thickness 16 mm). Pencils with barrels made from this blend were easy to sharpen.

### EXAMPLE 8

57.5% by weight of the crystal clear syndiotactic polypropylene used in Example 2 were blended with 30% by weight of the polymethyl methacrylate used in Example 4, 10% by weight of polyvinyl butyral used in Example 7 and 2.5% by weight of the tackifying resin used in Example 5. Courier 12pt text could be read through a stack of eight 2 mm thick sheets of this blend (total thickness 16 mm). Pencils with barrels made from this blend were easy to sharpen.

### EXAMPLE 9

90% by weight of a cyclic olefin copolymer (ex Ticona—refractive index 1.53) were blended with 10% by weight of nylon 6 (refractive index 1.53). Courier 12pt text could be read through a stack of four 2 mm thick sheets of this blend (total thickness 8 mm). Pencils with barrels made from this blend were easy to sharpen.

It is believed that the semicrystalline nature of the nylon 6 led to the relatively low transparency of this blend.

### EXAMPLE 10

80% by weight of crystal clear polystyrene (refractive index 1.59) was melt blended with 20% by weight of bisphenol-A polycarbonate (Durolon IR-2500, refractive index 1.586). Courier 12pt text could be read through a stack of ten 2 mm thick sheets of this blend (total thickness 20 mm). Pencils with barrels made from this blend were easy to sharpen.

1. Pencils having a core within a barrel, the barrel comprising a blend of at least two transparent polymers which are incompatible and form separate phases within the blend, the polymers having refractive indices which differ by not more than 0.02 when measured under substantially the same conditions.

2. Pencils according to claim 1, wherein the blend is sufficiently transparent that Courier 12pt text can be read through a thickness of at least 6 mm.

3. Pencils according to claim 2, wherein the blend is sufficiently transparent that Courier 12pt text can be read through a thickness of at least 20 mm.

4. Pencils according to claim 1, wherein the blend comprises at least 10% by weight of each of the incompatible polymers.

5. Pencils according to claim 1, wherein the blend contains syndiotactic polypropylene.

6. Pencils according to claim 5, wherein the blend contains from 40 to 90% by weight of syndiotactic polypropylene.

7. Pencils according to claim 5, wherein the incompatible polymer comprises polyvinyl acetal, cellulose acetate, poly-(oxymethylene), polyvinyl butyral, poly-(n-hexyl methacrylate), poly-(n-butyl methacrylate), poly-(ethylidene methacrylate), poly-(2-ethoxyethyl methacrylate), poly-(ethylene maleate), poly-(n-propyl methacrylate), poly-(3,3,5-tri-methyl-cyclohexyl methacrylate), poly-(ethyl methacrylate), poly-(2-nitro-2-methylpropyl methacrylate), poly-(triethylcarbinyl methacrylate), poly-(1,1-diethyl methacrylate), poly-(methyl methacrylate), poly-(2-decyl-buta-1,3-diene), polyvinyl alcohol, poly-(ethylglycolate meth-acrylate), poly-(3-methylcyclohexyl methacrylate), poly-(cyclo-hexyl α-ethoxyacrylate), methyl cellulose, poly-(4-methylcyclo-hexyl methacrylate), and poly-(decamethylene glycol dimeth-acrylate).

8. Pencils according to claim 1, wherein the blend contains polystyrene.

9. Pencils according to claim 8, wherein the polystyrene comprises a styrene homopolymer.

10. Pencils according to claim 8, wherein the incompatible polymer comprises a polycarbonate.

11. Pencils according to claim 10, wherein the incompatible polymer comprises a bisphenol-A polycarbonate.

12. Pencils according to claim 1, wherein the blend contains a cyclic olefin copolymer.

13. Pencils according to claim 12, wherein the incompatible polymer comprises a polyamide or a styrene/butadiene copolymer.

14. A method of producing pencils which comprises coextruding a lead forming material and a barrel forming material, the barrel forming material comprising a blend of incompatible transparent polymers having a refractive indices which differ by not more than 0.02 when measured under substantially the same conditions.

15. A method according to claim 14, wherein the pencils produced are as defined in claim 1.
